(19) United States
(12) Patent Application Publication
(10) Pub. No.: US 2002/0057342 A1
(43) Pub. Date: May 16, 2002

(54) Surveillance system

(76) Inventors: Takashi Yoshiyama, Higashiosaka-shi (JP); Shunjirou Yui, Osaka (JP); Kenichi Ishio, Toyonaka-shi (JP); Shinichi Mori, Hirakata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/986,663

(22) Filed: Nov. 9, 2001

(30) Foreign Application Priority Data
Nov. 13, 2000 (JP) 2000-344644
Nov. 16, 2000 (JP) 2000-349522

(51) Int. Cl. H04N 7/18

(52) U.S. Cl. 348/153

(57) ABSTRACT

A surveillance system makes it possible to confirm the state of a sensing area of a sensor in a house in a location separate from the house. An open/close sensor 201, a vibration sensor 203, and a fire sensor 205, are installed in the house 10. Cameras 202, 204, 206 are provided so as to photograph the respective sensing areas of the sensors 201, 203, 205. An information processing unit 300 is connected to an information communications network 400 which is constructed using an electrical power distribution network of a power company, and images, which are photographed by the cameras 202, 204, 206 when the sensors 201, 203, 205 sense unusual event information, are transmitted to a mobile terminal 100, which is owned by a customer of the power company, via the information communications network 400.

### BACKGROUND OF THE INVENTION

1. Field of the Invention

The present invention relates to a surveillance system that makes it possible to confirm the state of a house that is subject to surveillance, in a location separate from the house.

2. Description of the Related Art

A conventional surveillance system involves the installation of a television camera or the like in a house that is subject to surveillance, of a monitor in another location, the wire-based or wireless transmission of television camera images to the monitor, and the display of images, which are photographed using the television camera, on the monitor.

Conventional surveillance systems are capable of photographing the state of a house that is subject to surveillance and devices for the transmission and display of photographed images are exceedingly cumbersome and also costly. Consequently, household use of such systems, for example by means of which a resident may confirm the state of his or her own house from an outside location while he or she is not at home, has proved problematic.

Furthermore, there are frequent cases in which various sensors, such as fire sensors, gas leak sensors, door open/close sensors, and window vibration sensors, or the like, are provided in houses for the purpose of crime and disaster prevention. However, it has proved difficult, in an outside location, to know that such sensors are in an operating state. Further, even if it is possible to know this, it is difficult to confirm whether or not a sensor is malfunctioning.

### SUMMARY OF THE INVENTION

The present invention has been developed to overcome the above-described disadvantages.

It is accordingly an objective of the present invention to provide a surveillance system that makes it possible to readily confirm the state of a house, by means of a low-cost constitution, in a location separate from the house subject to surveillance.

Another objective of the present invention is to provide a surveillance system that makes it possible to know that an unusual event has been sensed by a sensor installed in a house, in a location separate from the house.

A further objective of the present invention is to provide a surveillance system that makes it possible to readily confirm the state of a sensing area of a sensor in a house, by means of a low-cost constitution, in a location separate from the house subject to surveillance.

Yet another objective of the present invention is to provide a surveillance system that makes it possible to confirm whether or not a sensor is malfunctioning.

In accomplishing the above and other objectives, a surveillance system according to the present invention includes a mobile terminal owned by a user, a camera mounted on a part of the house, which is specified by the user, and an information processing unit operable to transmit an image photographed by the camera to the mobile terminal in accordance with an instruction from the mobile terminal.

By means of this constitution, through manipulation by the user of the mobile terminal, an instruction is given by the mobile terminal to the information processing unit, which in turn transmits an image photographed by the camera to the mobile terminal. By so doing, the image transmitted by the information processing unit is displayed on a display screen of the mobile terminal. As a result, by looking at the screen of the mobile terminal, the user is able to confirm the state of the house by means of the transmitted image. Accordingly, even if the user is in a position separate from the house subject to surveillance, if the user is carrying the mobile terminal, he or she is able to confirm the state of the house, in this location and in a straightforward manner. Moreover, the user is able to take appropriate measures in the form of a report or the like, to a relevant association, with respect to the state of the house. In addition, the mobile terminal is inexpensive in comparison with reception equipment used for surveillance, and it is thus possible to keep equipment costs low.

Alternatively, a surveillance system includes a mobile terminal owned by a user, a sensor mounted on a part of the house, which is specified by the user, and an information processing unit operable to transmit information from the sensor to the mobile terminal.

By means of this constitution, when the sensor senses information, this information is sent to the information processing unit. As a result, the information processing unit transmits the information from the sensor to the mobile terminal. By so doing, information from the sensor, which is transmitted by the information processing unit, is displayed on the display screen of the mobile terminal. As a result, by looking at the screen of the mobile terminal, the user is able to know that information has been sensed by the sensor. Accordingly, even if the user is in a position separate from the house subject to surveillance, if the user is carrying the mobile terminal, he or she is able to know that information has been sensed by the sensor in the house, in this location and in a straightforward manner. Moreover, the user is able to take appropriate measures in the form of a report or the like, to a relevant association, with respect to the sensing area of the sensor in the house.

Again alternatively, a surveillance system includes a mobile terminal owned by a user, a sensor mounted on a part of the house, which is specified by the user, and an information processing unit operable to transmit, when the sensor senses unusual event information, a text message corresponding to the unusual event information to the mobile terminal.

By means of this constitution, when the sensor senses unusual event information, this unusual event information is sent to the information processing unit, which in turn transmits a text message, corresponding to the unusual event information from the sensor, to the mobile terminal. By so doing, the text message transmitted by the information processing unit is displayed on the display screen of the mobile terminal. As a result, by looking at the screen of the mobile terminal, the user is able to know, in a straightforward manner, that the unusual event information has been sensed by the sensor in the house and is able to know with certainty what kind of unusual event has occurred. Moreover, when a plurality of different sensors are present, the user is able to distinguish between different kinds of unusual events. Accordingly, even if the user is in a position separate from the house subject to surveillance, if the user is carrying the mobile terminal, he or she is able to know, in this location, that the unusual event information has been detected by the sensor, and also know the nature of the unusual event information.

The surveillance system may includes both the sensor and the camera. In this case, the information processing unit transmits, when the sensor senses unusual event information, an image photographed by the camera to the mobile terminal.

By means of this constitution, when the sensor senses unusual event information, this unusual event information is sent to the information processing unit. Then, the camera photographs the state of the sensing area of the sensor when the sensor senses this unusual event information, and the information processing unit transmits an image photographed by the camera to the mobile terminal. By so doing, the image transmitted by the information processing unit is displayed on the display screen of the mobile terminal. As a result, by looking at the screen of the mobile terminal, the user is able to confirm the state of the sensing area of the sensor in the house by means of the image, and is able to know whether or not the sensor is malfunctioning. Accordingly, even if the user is in a position separate from the house, if the user is carrying the mobile terminal, he or she is able to confirm, in this location and in a straightforward manner, the state of the sensing area of the sensor and whether or not the sensor is malfunctioning.

The information processing unit may have a memory that cumulatively stores images photographed by the camera when the sensor senses unusual event information. In this case, the information processing unit transmits an image in the memory to the mobile terminal in accordance with an instruction from the mobile terminal.

By means of this constitution, the information processing unit temporarily cumulatively stores images, which are photographed by the camera, in the memory. Thereafter, through manipulation by the user of the mobile terminal, when an instruction is given by the mobile terminal to the information processing unit, the information processing unit transmits images, which have been cumulatively stored in the memory, to the mobile terminal. Since the images are temporarily cumulatively stored in the memory and the transmission of images is requested through manipulation of the mobile terminal, the user is able to confirm the image at any time.

The information processing unit may transmit unusual event information to the mobile terminal, when the sensor senses the unusual event information.

By means of this constitution, when the sensor senses unusual event information, this unusual event information is sent to the information processing unit, which in turn transmits the unusual event information from the sensor to the mobile terminal. The unusual event information from the sensor is then displayed on the display screen of the mobile terminal. Therefore, the user knows that the images of the house are cumulatively stored in the memory, and, through speedy manipulation of the mobile terminal, is thus able to request the transmission of such images to the mobile terminal. Accordingly, the user is able to confirm the state of the house with barely any delay after the sensing operation by the sensor.

It is preferred that a lighting fixture installed in the house be turned on, when the camera is in operation.

By so doing, it is possible to obtain bright images, even in circumstances where the intensity of illumination is not sufficient for photography, for example, at night.

It is also preferred that the mobile terminal be a mobile telephone. In this case, there is no need to especially carry a special mobile terminal to confirm the state of the house. This means that the state of the house can be readily confirmed, and the burden on the user of being made to carry a mobile terminal, when going out for example, is minimized.

The sensor may be any one of a door open/close sensor, a fire sensor, a window vibration sensor and a gas leak sensor. These sensors can detect the opening and closing of a door, fire, vibrations of a window or leakage of gas.

The information processing unit can be installed in the house.

Conveniently, the surveillance system is provided with a switch operable to switch between operation and non-operation of the camera.

With the use of the switch, the user can arbitrarily set the start time and finish time for surveillance by the camera as occasion demands. It is, for example, possible to suspend the operation of the camera when surveillance by the camera is not required, for instance when the user is at home, to thereby attempt to preserve the privacy of the user.

In another aspect of the present invention, a surveillance system for confirming the state of a house includes an information communications network constructed using an electrical power distribution network of a power company, a mobile terminal owned by a customer of the power company, a camera mounted on a part of the house, which is specified by the customer, and an information processing unit connected to the information communications network for transmitting an image photographed by the camera to the mobile terminal in accordance with an instruction from the mobile terminal.

By means of this constitution, through manipulation by the customer of the mobile terminal, an instruction is given by the mobile terminal to the information processing unit, which in turn transmits an image photographed by the camera to the mobile terminal. The image transmitted by the information processing unit is then displayed on a display screen of the mobile terminal. As a result, by looking at the screen of the mobile terminal, the customer is able to confirm the state of the house by means of such an image. Accordingly, even if the user is in a position separate from the house, if the user is carrying the mobile terminal, he or she is able to confirm the state of the house, in this location and in a straightforward manner. Moreover, the customer is able to take appropriate measures in the form of a report or the like, to a relevant association, with respect to the state of the house.

Alternatively, a surveillance system includes an information communications network constructed using an electrical power distribution network of a power company, a mobile terminal owned by a customer of the power company, a sensor mounted on a part of the house, which is specified by the customer, and an information processing unit connected to the information communications network for transmitting information from the sensor to the mobile terminal.

By means of this constitution, when the sensor senses information, this information is sent to the information processing unit, which in turn transmits the information from the sensor to the mobile terminal. The information from the sensor, which is transmitted by the information processing unit, is then displayed on the display screen of the mobile terminal. As a result, by looking at the screen of the mobile terminal, the customer is able to know that the information has been sensed by the sensor in the house. Accordingly, even if the customer is in a position separate from the house, if the user is carrying the mobile terminal, he or she is able to know that the information has been sensed by the sensor, in this location and in a straightforward manner.

The information processing unit may be so designed as to transmit, when the sensor senses unusual event information, a text message corresponding to the unusual event information to the mobile terminal.

By means of this constitution, when the sensor senses unusual event information, this unusual event information is sent to the information processing unit, which in turn transmits a text message, corresponding to the unusual event information from the sensor, to the mobile terminal. By so doing, the text message transmitted by the information processing unit is displayed on the display screen of the mobile terminal. As a result, by looking at the screen of the mobile terminal, the customer is able to know, in a straightforward manner, that the unusual event information has been sensed by the sensor in the house and is able to know with certainty what kind of unusual event has occurred. Moreover, when a plurality of different sensors are present, the customer is able to distinguish between different kinds of unusual events. Accordingly, even if the customer is in a position separate from the house, if the customer is carrying the mobile terminal, he or she is able to know, in this location, that the unusual event information has been detected by the sensor, and also know the nature of the unusual event information.

The surveillance system may include both the sensor and the camera. In this case, the information processing unit connected to the information communications network transmits, when the sensor senses unusual event information, an image photographed by the camera to the mobile terminal.

By means of this constitution, when the sensor senses unusual event information, this unusual event information is sent to the information processing unit. Then, the camera photographs the state of the sensing area of the sensor when the sensor senses this unusual event information, and the information processing unit transmits an image photographed by the camera to the mobile terminal. By so doing, the image transmitted by the information processing unit is displayed on the display screen of the mobile terminal. As a result, by looking at the screen of the mobile terminal, the customer is able to confirm the state of the sensing area of the sensor in the house by means of the image, and is able to know whether or not the sensor is malfunctioning. Accordingly, even if the customer is in a position separate from the house, if the customer is carrying the mobile terminal, he or she is able to confirm, in this location and in a straightforward manner, the state of the sensing area of the sensor and whether or not the sensor is malfunctioning.

The information processing unit may have a memory that cumulatively stores images photographed by the camera when the sensor senses unusual event information. In this case, the information processing unit connected to the information communications network transmits an image in the memory to the mobile terminal in accordance with an instruction from the mobile terminal.

By means of this constitution, the information processing unit temporarily cumulatively stores images, which are photographed by the camera, in the memory. Thereafter, through manipulation by the customer of the mobile terminal, when an instruction is given by the mobile terminal to the information processing unit, the information processing unit transmits images, which have been cumulatively stored in the memory, to the mobile terminal. Since the images are temporarily cumulatively stored in the memory and the transmission of images is requested through manipulation of the mobile terminal, the customer is able to confirm the image at any time.

The information processing unit may be installed in a data center constituted on the information communications network.

By this arrangement, the information processing unit is not required to be provided for each customer, making it possible to keep equipment costs low on the customer side.

Furthermore, the data center may be so designed as to perform the following two kinds of processing. The first processing is processing in which, during a fixed period specified by the customer on the basis of a commission from the customer to the data center, the data center transmits, in place of the customer, reports to a relevant association in response to the information from the sensor.

By means of this constitution, the following action is taken. When the customer's circumstances are such that a state arises, for example, in which the mobile telephone breaks down, has a flat battery, is lost, or is out of range, or a state arises in which the mobile telephone cannot be used, for example when the user is on a trip overseas, the customer becomes unable to receive sensor information from the house, and is therefore unable to take appropriate measures in the form of a report or the like, to a relevant association with respect to the state of the house. In such a case, when the customer commissions the data center in advance to act, for a fixed period, as a representative for transmitting reports to a relevant association as occasion demands, it is possible to improve the reliability of the surveillance system in that, on the basis of this commission from the customer, during a fixed period specified by the customer, the data center transmits, in place of the customer, reports to a relevant association in response to the information from the sensor.

The second processing is processing in which, during a fixed period specified by the customer on the basis of a commission from the customer to the data center, the data center transmits, in place of the customer, reports to a relevant association when the data center has confirmed that an unusual event has occurred in the house as a result of confirming information from the camera.

By means of this constitution, if the customer becomes unable to receive information from the camera in the house, the customer commissions the data center in advance to act as a representative for transmitting reports to a relevant association as occasion demands. Accordingly, on the basis of the commission from the customer, the data center transmits, in place of the customer, reports to the relevant association when the data center has confirmed that an unusual event has occurred in the house upon confirmation of the information from the camera.

In a further aspect of the present invention, a surveillance system for confirming a state of a house of a customer of a power company includes an information communications network constructed using an electrical power distribution network of a power company, a gateway unit installed on the house and connected to the information communications network for sending inspection results, of an automated inspection of measurement of electricity consumed by the customer, to the information communications network, a mobile terminal owned by the customer, a camera mounted on a part of the house, which is specified by the customer, and an information processing unit connected to the information communications network for transmitting an image photographed by the camera to the mobile terminal in accordance with an instruction from the mobile terminal.

By means of this constitution, through manipulation by the customer of the mobile terminal, an instruction is given by the mobile terminal to the information processing unit, which in turn transmits an image photographed by the camera to the mobile terminal. By so doing, the image transmitted by the information processing unit is displayed on a display screen of the mobile terminal. As a result, by looking at the screen of the mobile terminal, the customer is able to confirm the state of the house by means of the transmitted image. Accordingly, even if the customer is in a position separate from the house, if the customer is carrying the mobile terminal, he or she is able to confirm the state of the house, in this location and in a straightforward manner. Moreover, the customer is able to take appropriate measures in the form of a report or the like, to a relevant association, with respect to the state of the house.

Alternatively, a surveillance system includes an information communications network constructed using an electrical power distribution network of a power company, a gateway unit installed on the house and connected to the information communications network for sending inspection results, of an automated inspection of measurement of electricity consumed by the customer, to the information communications network, a mobile terminal owned by the customer, a sensor mounted on a part of the house, which is specified by the customer, and an information processing unit connected to the information communications network for transmitting information from the sensor to the mobile terminal.

By means of this constitution, when the sensor senses information, this information is sent to the information processing unit, which in turn transmits the information from the sensor to the mobile terminal. The information from the sensor is then displayed on the display screen of the mobile terminal. As a result, by looking at the screen of the mobile terminal, the customer is able to know that the information has been sensed by the sensor. Accordingly, even if the customer is in a position separate from the house, if the customer is carrying the mobile terminal, he or she is able to know that the information has been sensed by the sensor in the house, in this location and in a straightforward manner. Moreover, the customer is able to take appropriate measures in the form of a report or the like, to a relevant association, with respect to the sensing area of the sensor in the house.

The information processing unit connected to the information communications network may be so designed as to transmit, when the sensor senses unusual event information, a text message corresponding to the unusual event information to the mobile terminal.

By means of this constitution, when the sensor senses unusual event information, this unusual event information is sent to the information processing unit, which in turn transmits a text message, corresponding to the unusual event information from the sensor, to the mobile terminal. By so doing, the text message transmitted by the information processing unit is displayed on the display screen of the mobile terminal. As a result, by looking at the screen of the mobile terminal, the customer is able to know, in a straightforward manner, that the unusual event information has been sensed by the sensor in the house and is able to know with certainty what kind of unusual event has occurred. Moreover, when a plurality of different sensors are present, the customer is able to distinguish between different kinds of unusual events. Accordingly, even if the customer is in a position separate from the house, if the customer is carrying the mobile terminal, he or she is able to know, in this location, that the unusual event information has been detected by the sensor, and also know the nature of the unusual event information.

The surveillance system may includes both the sensor and the camera, In this case, the information processing unit transmits, when the sensor senses unusual event information, an image photographed by the camera to the mobile terminal.

By means of this constitution, when the sensor senses unusual event information, this unusual event information is sent to the information processing unit. Then, the camera photographs the state of the sensing area of the sensor when the sensor senses the unusual event information, and the information processing unit transmits an image photographed by the camera to the mobile terminal. By so doing, the image transmitted by the information processing unit is displayed on the display screen of the mobile terminal. As a result, by looking at the screen of the mobile terminal, the customer is able to confirm the state of the sensing area of the sensor in the house by means of the image, and is able to know whether or not the sensor is malfunctioning. Accordingly, even if the customer is in a position separate from the house, if the customer is carrying the mobile terminal, he or she is able to confirm, in this location and in a straightforward manner, the state of the sensing area of the sensor and whether or not the sensor is malfunctioning.

The information processing unit may have a memory that cumulatively stores images photographed by the camera when the sensor senses unusual event information. In this case, the information processing unit transmits an image in the memory to the mobile terminal in accordance with an instruction from the mobile terminal.

By means of this constitution, the information processing unit temporarily cumulatively stores images, which are photographed by the camera, in the memory. Thereafter, through manipulation by the customer of the mobile terminal, when an instruction is given by the mobile terminal to the information processing unit, the information processing unit transmits images, which have been cumulatively stored in the memory, to the mobile terminal. Since the images are temporarily cumulatively stored in the memory and the transmission of images is requested through manipulation of the mobile terminal, the customer is able to confirm the image at any time.

The information processing unit may be installed in the house or contained in the gateway unit.

By means of this constitution, since the gateway unit is provided, if the same is utilized as an interface for connecting the information processing unit to the information communications network, no special constitution is required to connect the information processing unit to the information communications network.

Alternatively, the information processing unit may be installed in a data center that is constituted on the information communications network to receive inspection results by means of the gateway unit.

Since the information processing unit is installed in the data center, the installation of the information processing unit for each customer is unnecessary, and it is thus possible to keep equipment costs low on the customer side. In addition, since meter-reading equipment can be made to serve also as the information processing unit and there is therefore no requirement to add any new equipment, equipment costs on the data center side can also be kept low. Moreover, if the gateway unit is utilized as an interface for connecting cameras and/or sensors or the like to the information communications network, no special constitution is required to connect the cameras and/or sensors or the like to the information communications network.

### BRIEF DESCRIPTION OF THE DRAWINGS

The above and other objectives and features of the present invention will become more apparent from the following description of preferred embodiments thereof with reference to the accompanying drawings, throughout which like parts are designated by like reference numerals, and wherein:

FIG. 1 is a block diagram of a surveillance system according to a first embodiment of the present invention;

FIG. 2 is a block diagram of a surveillance system according to a second embodiment of the present invention;

FIG. 3 is a block diagram of a surveillance system according to a third embodiment of the present invention;

FIG. 4 is a block diagram of a surveillance system according to a fourth embodiment of the present invention;

FIG. 5 is a block diagram of a surveillance system according to a fifth embodiment of the present invention; and

FIG. 6 is a block diagram of a gateway unit.

### DETAILED DESCRIPTION OF THE PREFERRED EMBODIMENTS

This application is based on applications Nos. 2000-344644 and 2000-349522 filed Nov. 13 and 16, 2000, respectively, in Japan, the content of which is herein expressly incorporated by reference in its entirety.

First embodiment

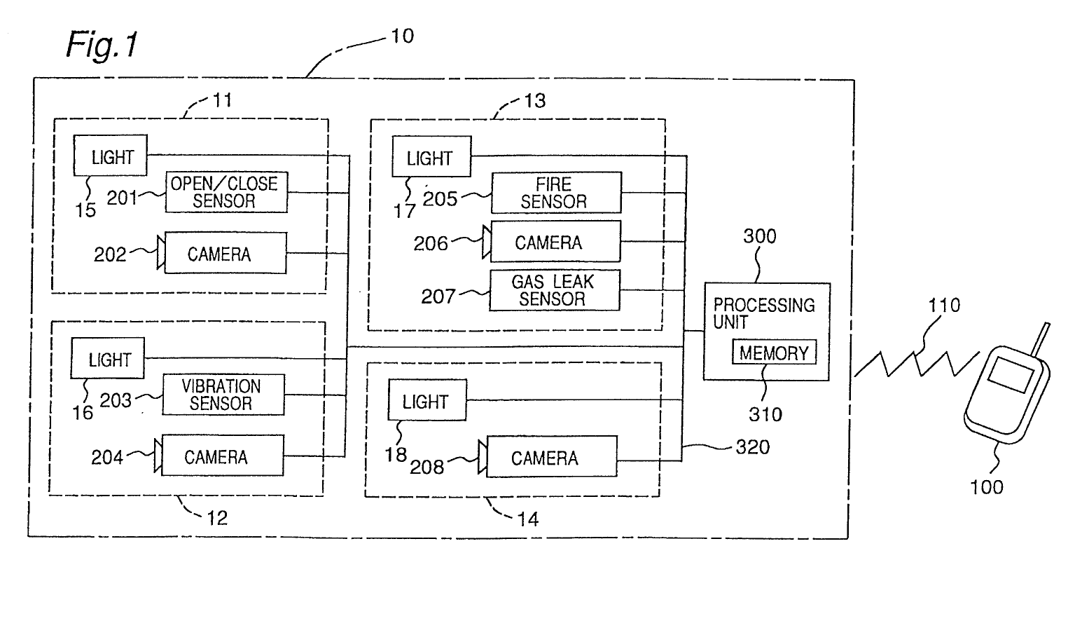

FIG. 1 shows a schematic view of a surveillance system relating to a first embodiment of the present invention. In FIG. 1, 100 represents a mobile terminal, for example a mobile telephone, which is owned by a user.

10 represents a house that is a user's residence; 11 represents a part of this house 10, for example the entranceway; 12 represents a part of this house 10, for example a window; 13 represents a part of this house 10, for example the kitchen; and 14 represents a part of this house 10, for example a room such as a bedroom or living room.

15 represents a lighting fixture for illuminating the entranceway 11; 16 represents a lighting fixture for illuminating the interior of a room that has the window 12; 17 represents a lighting fixture for illuminating the kitchen 13; and 18 represents a lighting fixture for illuminating a room 14 such as a bedroom or living room. These lighting fixtures have a constitution permitting remote control.

201 represents a door open/close sensor, which is mounted on the entranceway 11; 202 represents a camera, which is mounted on the entranceway 11 and which photographs the state of the entranceway 11, in other words the sensing area of the door open/close sensor 201. 203 represents a window vibration sensor, which is attached to the window 12; 204 represents a camera, which is installed inside the room that has the window 12 and which photographs the state of the window 12, in other words the sensing area of the window vibration sensor 203; 205 represents a fire sensor, such as a smoke detector, which is installed in the kitchen 13; 206 represents a camera, which is installed in the kitchen 13 and is for photographing the state of the kitchen 13, in other words the sensing area of the fire sensor 205; 207 represents a gas leak sensor, which is installed in the kitchen 13; and 208 represents a camera, which is installed in a room 14 such as a bedroom or a living room and is for photographing the state of the room 14.

Manual switches (not shown), for example, which are capable of switching between the states of operation and non-operation, may be provided in the above-mentioned cameras 202, 204, 206 and 208. Through manipulation of these switches, it is possible to switch, according to requirements, between operation and non-operation of the cameras 202, 204, 206 and 208 in order to arbitrarily set the start time and finish time for surveillance by means of the cameras 202, 204, 206 and 208. As a result, it is, for example, possible to suspend the operation of cameras 202, 204, 206 and 208 when surveillance by the cameras 202, 204, 206 and 208 is not required, for instance when a customer is at home, to thereby attempt to preserve the privacy of the user.

300 represents an information processing unit, which is constituted as an information processing unit and installed in an arbitrary location in the house 10, and which contains a memory 310; 320 represents signal lines, which connect the information processing unit 300 with the door open/close sensor 201, the camera 202, the window vibration sensor 203, the camera 204, the fire sensor 205 and camera 206 in the kitchen for example, the gas leak sensor 207 and camera 208 in the kitchen for example, and the lighting fixtures 15, 16, 17, 18. If a house wiring system is adopted for the transmission of signals, it is possible to employ lighting wires for the above-mentioned signal lines 320, meaning that special signal wiring is not required.

The functions of the information processing unit 300 will now be described.

The information processing unit 300 causes operation of the camera 208 in accordance with a corresponding instruction from the mobile telephone 100 via a public telephone line 110, and has a function of transmitting still images photographed by the camera 208 to the mobile telephone 100 via the public telephone line 110. Thereupon, the camera 208 performs processing to compress image data of the still images in order to supply this data, in a form in which the volume is reduced, to the information processing unit 300. Further, this processing to compress the image data may also be performed by the information processing unit 300. In addition, also with regard to the cameras 202, 204, 206, it is possible to cause image data to be transmitted at an arbitrary time by means of a corresponding instruction using the mobile telephone 100.

Furthermore, the information processing unit 300 temporarily stores image data of still images in the internal memory 310, and when this data is subsequently transmitted to the mobile telephone 100, the information processing unit 300 reads out the image data from the memory 310 to perform data processing for the transmission of this data.

In the description above, the photographic operation is executed through operation of the camera 208 in accordance with an instruction from the mobile telephone 100. However, it is also possible that the camera 208 be kept in operation, and only when an instruction is given from the mobile telephone 100, the images photographed by the camera 208 at this time be picked up by the information processing unit 300. In addition, images photographed by the normally operating camera 208 may also be recorded especially by recording means.

When the camera 208 is in operation and in cases where there is not a sufficient amount of tight on a photographic object, for example during nighttime photography, it is effective for the information processing unit 300 to turn on the lighting fixture 18 in the room 14, i.e., the photographic object, in order to brighten the room 14 and obtain bright images. In addition, unlike the case in which the lighting fixture 18 is always kept on for photography, it is possible to achieve an economical use of energy.

Furthermore, the information processing unit 300 has a function of transmitting information, from the door open/close sensor 201, the window vibration sensor 203, the fire sensor 205, and the gas leak sensor 207, to the mobile telephone 100 via the public telephone line 110, in the form of text, symbols, sound, and so forth. In this event, it is preferable that the information processing unit 300 should transmit a text message corresponding to the nature of the unusual event information sensed by sensors 201, 203, 205, 207 to the mobile telephone 100 in order to inform the user which sensor this information is from.

Further, the information processing unit 300 has a function of causing operation of the camera 202, upon receiving unusual event information when same is sensed by the door open/close sensor 201, and of transmitting still images photographed by the camera 202 to the mobile telephone 100 via the public telephone line 110. Further, the information processing unit 300 has a function of causing operation of the camera 204, upon receiving unusual event information when same is sensed by the window vibration sensor 203, and of transmitting still images photographed by the camera 204 to the mobile telephone 100 via the public telephone line 110. In addition, the information processing unit 300 has a function of causing operation of the camera 206, upon receiving unusual event information when same is sensed by the fire sensor 205, and of transmitting still images photographed by the camera 206 to the mobile telephone 100 via the public telephone line 110.

At this moment, the cameras 202, 204, 206 perform processing to compress image data of the still images in order to supply this data, in a form in which the volume is reduced, to the information processing unit 300. Further, this processing to compress the image data may also be performed by the information processing unit 300. Furthermore, the information processing unit 300 temporarily stores image data of still images in the internal memory 310, and when this data is subsequently transmitted to the mobile telephone 100, the information processing unit 300 reads out image data from the memory 310 to perform data processing for the transmission of this data.

In the description above, the photographic operation is executed through operation of the cameras 202, 204, 206 in accordance with an instruction from the mobile telephone 100. However, it is also possible that the cameras 202, 204, 206 be kept in operation, and only when unusual event information is sensed by the sensors 201, 203, 205, the images photographed by the camera 202, 204, 206 at this time be picked up by the information processing unit 300. In addition, images photographed by the normally operating cameras 202, 204, 206 may also be recorded especially by recording means.

It is also preferable that, when the camera 202 is in operation, the information processing unit 300 should provide an instruction to turn on the lighting fixture 15 for the entranceway 11, i.e., the photographic object in order to brighten the entranceway 11. Also, it is preferable that, when the camera 204 is in operation, the information processing unit 300 should turn on the lighting fixture 16 for the room having the window 12, in order to brighten such a room. Further, it is preferable that, when the camera 206 is in operation, the information processing unit 300 should turn on the lighting fixture 17 for the kitchen 13, in order to brighten the kitchen 13. By so doing, in cases where there is not a sufficient amount of light on the photographic object, for example during nighttime photography, bright images can be effectively obtained. In addition, unlike the case in which the camera is kept on for photography, it is possible to achieve an economical use of energy.

The transmission to the mobile telephone 100 may be performed automatically, as described above, upon receiving an unusual event signal from the door open/close sensor 201, the window vibration sensor 203, or the fire sensor 205. However, in consideration of the status of the user (for example, the circumstances of the user's location, or the state of radio waves, or the like), it is preferable to adopt a form in which images photographed by the cameras 202, 204, 206 are cumulatively stored in the memory 310, and, in accordance with an instruction from the mobile telephone 100 via the public telephone line 110, still images photographed by the cameras 202, 204, 206 are transmitted to the mobile telephone 100 via the public telephone line 110.

Furthermore, by means of a constitution in which images are transmitted to the mobile telephone 100 in accordance with an instruction from the mobile telephone 100, there is barely any delay in the user confirming an unusual event, these images respectively being photographed by: the camera 202, when the door open/close sensor 201 senses the unusual event information; the camera 204 when the window vibration sensor 203 senses the unusual event information; or the camera 206, when the kitchen fire sensor 205 senses the unusual event information. The reason for this is that an unusual event signal, which is from the door open/close sensor 201, the window vibration sensor 203, or the kitchen fire sensor 205, is automatically transmitted to the user's mobile telephone 100 in the form of a text message. When unusual event information is picked up by the mobile telephone 100, if the user immediately uses his or her mobile telephone 100 to make an instruction to the information processing unit 300 to transmit images, there is no delay in the user confirming an unusual event.

Next, the operation of this surveillance system will be described hereinafter.

By means of this surveillance system, through manipulation by the user of the mobile telephone 100, an instruction is given by the mobile telephone 100 to the information processing unit 300. Then, the information processing unit 300 causes operation of the camera 208 installed in the room 14, whereby the state of the room 14 of the house 10 is photographed by means of the camera 208. In addition, the information processing unit 300 transmits a still image photographed by the camera 208 to the mobile telephone 100. By so doing, the still image transmitted by the information processing unit 300 is displayed on a display screen of the mobile telephone 100. As a result, by looking at the screen of the mobile telephone 100, the user is able to confirm the state of the room 14 of the house 10 by means of an image. Accordingly, even if the user is in a position separate from the house 10 subject to surveillance, if the user is carrying the mobile telephone 100, he or she is able to confirm the state of the room 14 of the house 10 in this location and in a straightforward manner. Moreover, the user is able to take appropriate measures in the form of a report, or the like, to a relevant association such as the nearest police station or fire station, with respect to the state of the house 10. In addition, the mobile telephone 100 is inexpensive in comparison with reception equipment used for surveillance, and it is thus possible to keep equipment costs low. The state of locations in which a camera has been installed (for example, the entranceway 11, the kitchen 13, or the room having the window 12) can be confirmed in the same way as described above.

By means of this surveillance system, when a sensor such as the door open/close sensor 201, the window vibration sensor 203, the kitchen fire sensor 205, or the kitchen gas leak sensor 207, senses unusual event information (the opening of the door, breakage of the glass of the window, the occurrence of a fire, or leakage of gas, or the like) this unusual event information is sent to the information processing unit 300. The information processing unit 300 then transmits text, symbols, or a text message, or the like, corresponding to the unusual event information from the door open/close sensor 201, the window vibration sensor 203, the kitchen fire sensor 205, or the kitchen gas leak sensor 207, to the mobile telephone 100. The unusual event information transmitted by the information processing unit 300 is displayed on the display screen of the mobile telephone 100 in the form of text, symbols or a text message, or the like. As a result, by looking at the screen of the mobile telephone 100, the user is able to know, in a straightforward manner, that information has been sensed by the sensor 201, 203, 205 or 207 in the house. Moreover, when a plurality of different sensors are present, the user is able to distinguish between different kinds of unusual event and is able to know with certainty what kind of unusual event has occurred. Even if the user is in a position separate from the house 10 subject to surveillance, if the user is carrying the mobile telephone 100, he or she is able to know, in this location, that information has been detected by a sensor 201, 203, 205 or 207 in the house 10, and also know the nature of the unusual event. Accordingly, the user is able to take appropriate measures in the form of a report, or the like, to a relevant association such as the nearest police station or fire station, with respect to the state of the house 10.

Alternatively, generic signals, which bear no relation to the nature of the unusual event, for example, may be sent to the mobile telephone 100. In such a case, it is not possible to learn of the nature of the unusual event, but it is nonetheless possible to confirm that an unusual event has occurred.

Further, by means of this surveillance system, when the sensor 201, 203 or 205 senses unusual event information, this unusual event information is sent to the information processing unit 300. As a result, the information processing unit 300 causes operation of the camera 202, 204 or 206 in order to photograph the state of the sensing area of the sensor 201, 203 or 205 in the house 10 using a camera. In addition, the information processing unit 300 transmits a still image photographed by the camera 202, 204 or 206 to the mobile telephone 100. By so doing, the still image transmitted by the information processing unit 300 is displayed on the display screen of the mobile telephone 100. As a result, by looking at the screen of the mobile telephone 100, the user is able to confirm the state of the sensing area of the sensor 201, 203 or 205 in the house by means of an image, and is able to know whether or not the sensor 201, 203 or 205 is malfunctioning. Accordingly, even if the user is in a position separate from the house 10, if the user is carrying the mobile telephone 100, he or she is able to confirm, in this location and in a straightforward manner, the state of the sensing area of the sensor 201, 203 or 205 in the house 10 and whether or not the sensor 201, 203 or 205 is malfunctioning.

Further, by means of this surveillance system, when the sensor 201, 203 or 205 senses unusual event information, this unusual event information is sent to the information processing unit 300. As a result, the information processing unit 300 causes operation of the camera 202, 204 or 206 in order to photograph the state of the sensing area of the sensor 201, 203 or 205 in the house using the camera 202, 204 or 206. In addition, the information processing unit 300 temporarily cumulatively stores still images, photographed by means of the camera 202, 204 or 206, in the memory 310. Thereafter, through manipulation by the user of the mobile telephone 100, when an instruction is given by the mobile telephone 100 to the information processing unit 300, the information processing unit 300 transmits still images, which have been cumulatively stored in the memory 310, to the mobile telephone 100. By so doing, the still images transmitted by the information processing unit 300 are displayed on the display screen of the mobile telephone 100. As a result, by looking at the screen of the mobile telephone 100, the user is able to confirm the state of the sensing area of the sensor 201, 203 or 205 in the house 10 by means of an image, and is able to know whether or not the sensor 201, 203 or 205 is malfunctioning. Accordingly, even if the user is in a position separate from the house subject to surveillance, if the user is carrying the mobile telephone 100, he or she is able to confirm, in this location and in a straightforward manner, the state of the sensing area of the sensor 201, 203 or 205 in the house 10 and also whether or not the sensor 201, 203 or 205 is malfunctioning. In addition, since still images are temporarily cumulatively stored in the memory 310 and the transmission of still images is requested through manipulation of the mobile telephone 100, the user is able to confirm still images of the house at any time.

By means of this constitution, when the sensor 201, 203 or 205 senses unusual event information, the information processing unit 300 may also transmit text, symbols or a text message, or similar, corresponding to the unusual event information, to the mobile telephone 100. Consequently, when the sensor 201, 203 or 205 senses unusual event information, this unusual event information is sent to the information processing unit 300. As a result, the information processing unit 300 transmits unusual event information from the sensor 201, 203 or 205 to the mobile telephone 100. By so doing, unusual event information from the sensor 201, 203 or 205 is displayed on the display screen of the mobile telephone 100. Therefore, the user knows that still images of the house 10 subject to surveillance are cumulatively stored in the memory 310, and, through speedy manipulation of the mobile telephone 100, is thus able to request the transmission of still images, which have been cumulatively stored in the memory 310, to the mobile telephone 100. Consequently, the user is capable of confirming the state of the sensing area of the sensor 201, 203 or 205 in the house 10 with barely any delay after the sensing operation by the sensor 201, 203 or 205.

In the constitution described above, when the camera 202, 204, 206, or 208 is being operated, it is preferable that a lighting fixture 15, 16, 17 or 18 in the vicinity of a photographic object in the house 10 be turned on. By so doing, it is possible to obtain bright still images, even in circumstances where insufficient illuminance is provided for photography using a camera, for example at night. As a result, unlike the case in which the lighting fixture 15, 16, 17 or 18 is kept on for photography, it is possible to achieve an economical use of energy.

It is preferable that a mobile telephone be employed as the mobile terminal. With a constitution of this kind, there is no need to especially carry a special mobile terminal to confirm the state of the house, meaning that it is possible to confirm the state of the house 10 or the state of the sensing area of the sensor 201, 203 or 205, as an image in a straightforward manner, and the burden on the user of being made to carry a mobile terminal, when going out for example, is minimized.

In the description above, photography is performed through operation of the cameras 202, 204, 206, 208 in response to an instruction from the mobile telephone 100 or to unusual event information from the sensors 201, 203, 205. However, it is also possible that the cameras 202, 204, 206, 208 themselves be always in operation, and in response to an instruction from the mobile telephone 100 or to unusual event information from the sensors 201, 203, 205, the information processing unit 300, for example, may pick up image data from the cameras 202, 204, 206, 208. In addition, images photographed by the normally operating cameras 202, 204, 206, 208 may also be recorded especially by recording means.

Second embodiment

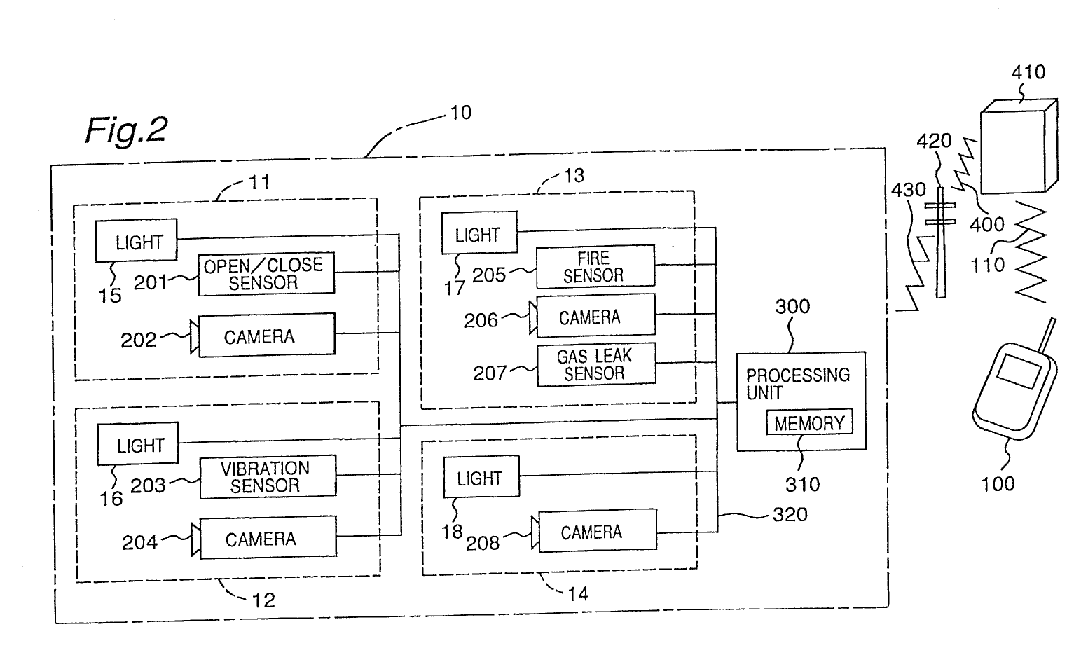

FIG. 2 shows a schematic view of a surveillance system relating to a second embodiment of the present invention. The characteristic feature of the second embodiment lies in the fact that, rather than performing direct transmission of signals between the information processing unit 300 and the mobile telephone 100, as is the case in the first embodiment, this transmission is performed via an information communications network that is constructed using an electrical power distribution network of a power company.

In FIG. 2, 400 represents an information communications network, which is constructed using an electrical power distribution network of a power company; 410 represents a data center, which is constituted on the information communications network 400; and 420 represents an electric light pole, which is disposed in the vicinity of the residence of the user, that is, the customer of the power company. A repeater (not shown) for the information communications network 400 is provided on the electric light pole 420.

The information communications network 400 has a transmission medium constituted by optical fibers laid integrally with power transmission lines, and is connected with the above-mentioned repeater. The repeater has a function of converting a signal carrier.

The information processing unit 300 is constituted so as to utilize a communications line 430 in a PHS system or a specific wireless system such as a low-power wireless system, for example, in order to transmit and receive various signal data to and from the repeater with which the electric light pole 420 is provided. The exchange of information between the data center 410 and the mobile telephone 100 is performed using the public telephone line 110.

The transmission of information between the repeater and the information processing unit 300 may also take the form of wire-based signal transmission (power supply system) using power lines. The same is true for subsequent embodiments.

Excepting the fact that an information communications network 400, which is constructed using an electrical power distribution network of a power company, lies between the information processing unit 300 and the mobile telephone 100, the second embodiment is the same as the first embodiment.

Accordingly, the effects of this embodiment are substantially similar to those of the first embodiment.

The above-mentioned data center 410 is able to perform the following two kinds of processing. More specifically, the first processing is processing in which, during a fixed period specified by the customer on the basis of a commission from the customer to the data center 410, the data center 410 transmit, in place of the customer, reports to a relevant association such as the nearest police station or fire station in response to information from the sensors 201, 203, 205, 207. This processing may be performed automatically by software of a computer that is installed in the data center 410, or may be performed by an operator assigned to the data center 410.

By means of this constitution, the following action is taken. When customer's circumstances are such that a state arises, for example, in which the mobile telephone 100 breaks down, has a flat battery, is lost, or is out of range, or a state arises in which the mobile telephone 100 cannot be used, for example when the user is on a trip overseas, the customer becomes unable to receive information of the sensors 201, 203, 205, 207 from the house 10 subject to surveillance, and is therefore unable to take appropriate measures in the form of a report, or the like, to a relevant association with respect to the state of the house 10. In such a case, when the customer commissions the data center 410 in advance to act, during a fixed period, as a representative for transmitting reports to a relevant association as occasion demands, it is possible to improve the reliability of the surveillance system in that, on the basis of this commission from the customer, during a fixed period specified by the customer, the data center 410 transmits, in place of the customer, reports to a relevant association in response to information from the sensors 201, 203, 205, 207 that is to be sent from the information processing unit 300 to the mobile telephone 100.

The second processing is processing in which, during a fixed period specified by the customer on the basis of a commission from the customer to the data center 410, the data center 410 transmits, in place of the customer, reports to a relevant association such as the nearest police station or fire station when the data center 410 has confirmed that an unusual event has occurred in the house 10 subject to surveillance as a result of confirming information from the cameras 202, 204, 206, 208. This processing may be performed automatically by software (also including image recognition processing, for example) of a computer that is installed in the data center 410, or may be performed by an operator assigned to the data center 410.

By means of this constitution, the following action is taken. More specifically, when customer's circumstances are such that a state arises, for example, in which the mobile telephone 100 breaks down, has a flat battery, is lost, or is out of range, or a state arises in which the mobile telephone 100 cannot be used, for example when the user is on a trip overseas, the customer becomes unable to receive information of the cameras 202, 204, 206, 208 from the house 10 subject to surveillance, and is therefore unable to take appropriate measures in the form of a report, or the like, to a relevant association with respect to the state of the house 10. In such a case, when the customer commissions a data center 410 in advance to act, for a fixed period, as a representative for transmitting reports to a relevant association as occasion demands, it is possible to improve the reliability of the surveillance system in that, on the basis of this commission from the customer, during a fixed period specified by the customer, the data center 410 transmits, in place of the customer, reports to a relevant association when the data center 410 has confirmed that an unusual event has occurred in the house 10 as a result of confirming information from the cameras 202, 204, 206, 208.

Third embodiment

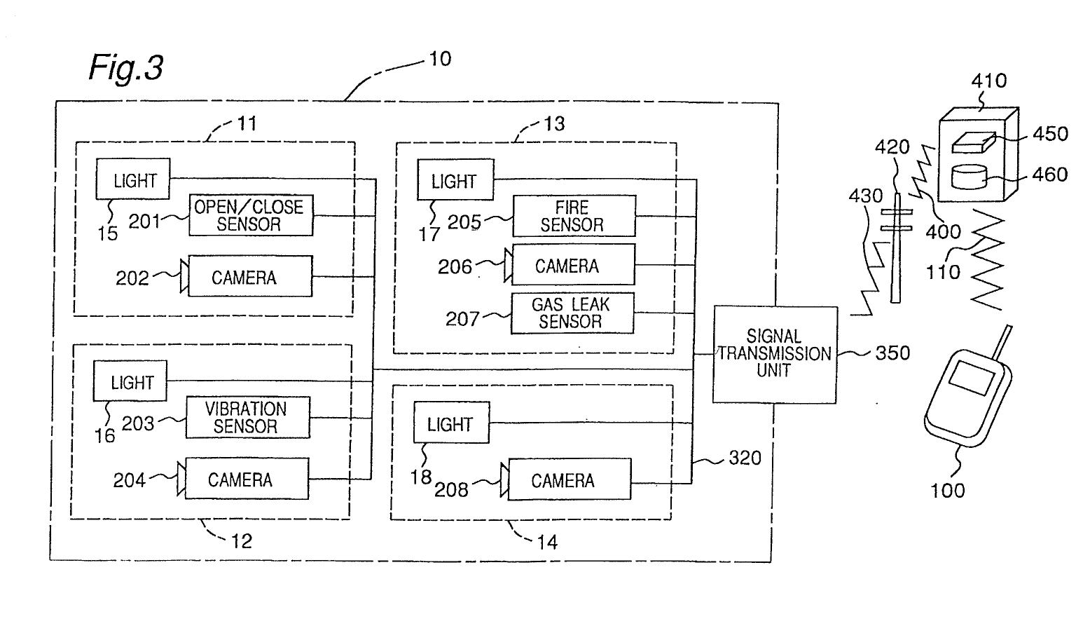

FIG. 3 shows a schematic view of a surveillance system relating to a third embodiment of the present invention. The third embodiment is such that, rather than the information processing unit 300 being disposed in the house 10 that is the residence of the customer, an information processing unit 450 and a memory 460 are installed in the data center 410 and accomplish the same functions as the information processing unit 300, and only a signal transmission unit 350 is installed in the house 10 as an interface for sending signals, from the cameras 202, 204, 206, 208 and the sensors 201, 203, 205, 207, to the repeater, with which the electric light pole 420 is provided, and for receiving commands transmitted via the information communications network 400 in order to supply these commands to the cameras 202, 204, 206, 208 and the lighting fixtures 15 to 18. Other constitutions are similar to those of the second embodiment.

According to this embodiment, since the information processing unit 450 and the memory 460 are installed in the data center 410, the installation of an information processing unit for each customer is unnecessary, and it is thus possible to keep equipment costs low on the customer side. Other effects are substantially similar to those of the first embodiment.

With this embodiment, similarly to the second embodiment, the data center 410 is capable of performing two kinds of processing as described above, and the effects of this embodiment are the same as those of the second embodiment.

Fourth embodiment

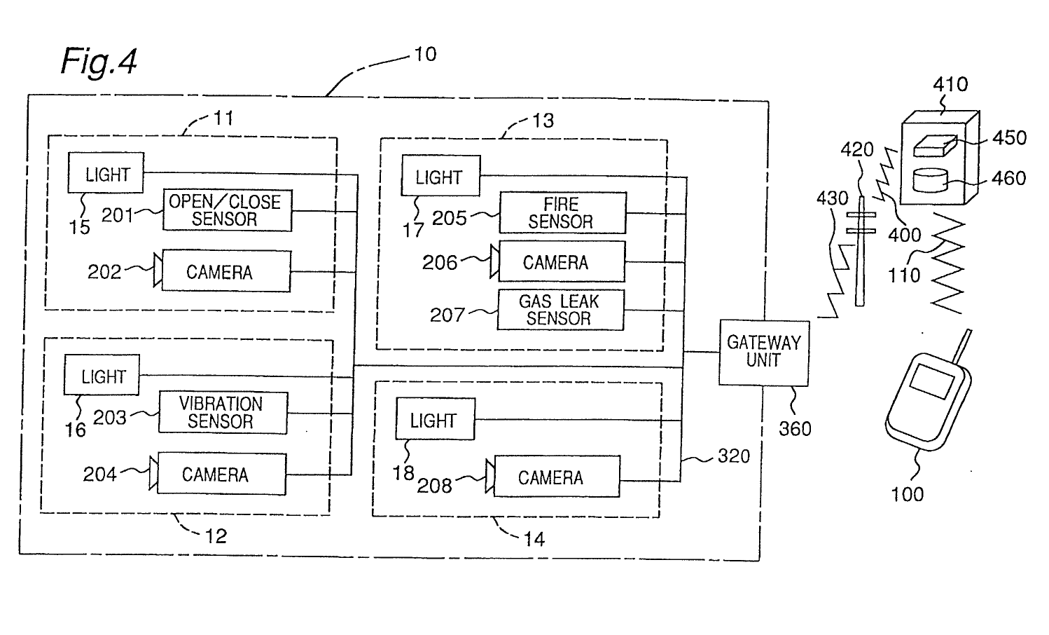

FIG. 4 shows a schematic view of a surveillance system relating to a fourth embodiment of the present invention. This embodiment is such that, rather than a signal transmission unit 350 being especially provided, a gateway unit 360 is employed, which is installed on the residence of a customer of a power company and connected to the information communications network 400, and which sends the inspection results, of an automated inspection of measurement of the electricity consumed by each customer, to the information communications network 400. Other constitutions are similar to those of the third embodiment.

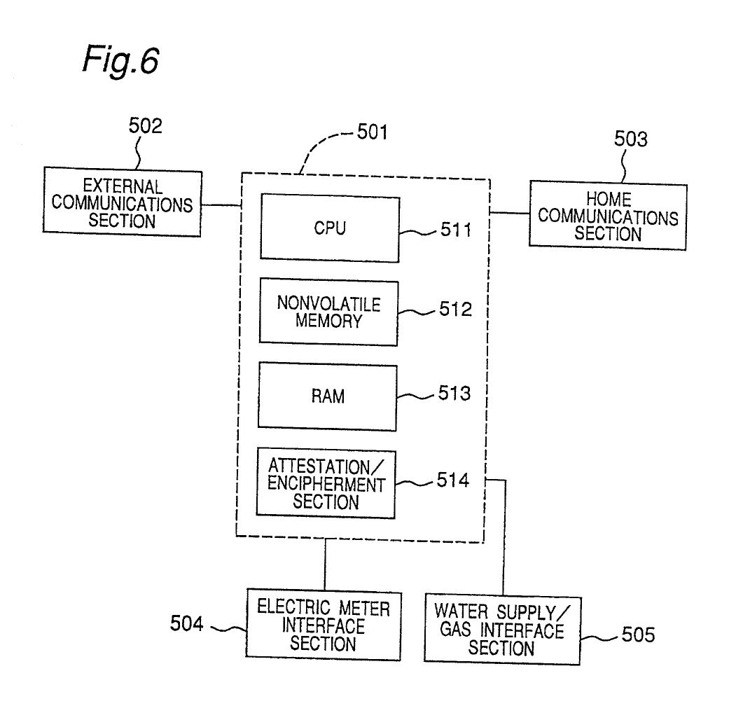

The actual constitution of the gateway unit 360 will be discussed hereinafter with reference to FIG. 6.

This gateway unit 360 is installed as an infrastructure for an electric meter inspection. As shown in FIG. 6, the gateway unit 360 is constituted by a main body circuit 501, an external communications section 502 for performing communications with the power company data center via the repeater and the information communications network, a home communications section 503, which employs a power supply system for example, for performing signal transmission between the sensors, cameras and lighting fixtures installed in the home, an electric meter interface section 504 for performing an inspection of an electric meter, and a water supply/gas meter interface section 505 for performing an inspection of the water supply and gas meters. In addition to performing an inspection of the amount of electricity consumed and an inspection of the amounts of gas and water used, the gateway unit 360 provides a communications line that interconnects the sensors, cameras, and lighting fixtures to the data center.

The main body circuit 501 comprises a CPU 511, a re-writable nonvolatile memory 512 for storing software, a RAM 513, and an attestation/encipherment section 514. The attestation/encipherment section 514 sets a physical address.

The main body circuit 501 is capable of updating and adding programs from outside by means of the rewritable non-volatile memory 512 that contains application programs. Since the application processing is shared by the gateway unit 360, a system constitution is possible that permits essential functions to be satisfied even by a low-cost mobile terminal device.

The functions of the above-mentioned gateway unit are as follows:

1. Electric meter inspection function.

2. Information buffer function.

A function according to which, on the basis of information sent from the data center, instructions to take a photograph are supplied to cameras or the like in the home, or instructions are made to turn on or off lighting fixtures, or signals from sensors or cameras are transferred to the data center.

3. Capable of adding new programs from the data center and updating existing software, in accordance with a request from a customer (user).

4. Capable of improving efficiency by means of joint inspection by virtue of having an interface with gas and water supply meters.

5. The communications section has a separable structure, and is therefore easily adapted in keeping with technological change.

The external communications section 502 has a structure, which, whether the connection is to be wire-based or wireless, permits a selection between interfaces that are usable depending on the given geographical region. The possible use of a PHS, high-speed wireless technology, or optical fibers, and, in the future, the possible use of a high-speed transmission with the use of the power supply system, may be considered here.

When the gateway unit 360 is employed in this way as an interface for sending signals, from the cameras 202, 204, 206, 208 and the sensors 201, 203, 205, 207, to the repeater, with which the electric light pole 420 is provided, and for receiving commands transmitted via the information communications network 400 in order to supply these commands to the cameras 202, 204, 206, 208 and the lighting fixtures 15 to 18, the provision of a new signal transmission unit is unnecessary. It is thus possible to keep equipment costs still lower on the customer side. Other effects are the same as those of the third embodiment.

In addition, since meter-reading equipment can be so utilized as to serve also as the information processing unit 450 and the memory 460, and there is therefore no need to add any new equipment, equipment costs for the data center 410 can also be kept low.

With this embodiment, similarly to the second embodiment, the data center 410 is capable of performing two kinds of processing as described above, and the effects of this embodiment are the same as those of the second embodiment.

Fifth embodiment

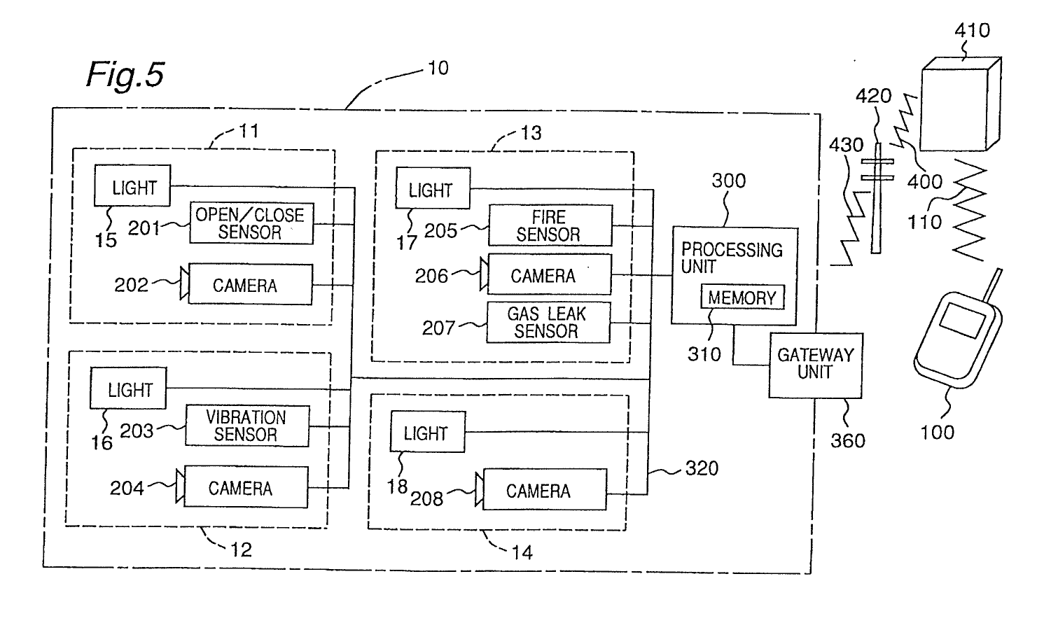

FIG. 5 shows a schematic view of a surveillance system relating to a fifth embodiment of the present invention. The fifth embodiment is such that an information processing unit 300 is installed in the house 10 of a customer of a power company, and a gateway unit 360 is employed, which is installed on the residence of the customer and connected to the information communications network 400 as an interface (signal transmission unit) to permit the transportation of signals of the information processing unit 300 on the information communications network 400, and which sends the inspection results, of an automated inspection of measurement of the electricity consumed by the customer, to the information communications network 400. Other constitutions are similar to those of the second embodiment.

Further, functions equivalent to those of the information processing unit 300 and the memory 310 may also be contained in the gateway unit 360.

With a constitution of this kind, it is not necessary to especially provide the information processing unit 300 with an interface to transmit and receive various signal data from and to the repeater with which the electric light pole 420 is provided. As a result, the constitution of the information processing unit 300 is simple, and equipment costs are therefore low. Other effects are the same as those of the second embodiment.

In each of the embodiments above, a mobile telephone is employed as the mobile terminal. However, the mobile terminal is not limited to a mobile telephone and may equally be a portable computer device having a display screen. Further, in cases where still images are not displayed, a pocket bell or the like may be employed. Also, in the embodiments above, the transmission of still images is described. However, these images need not be limited to still images, and if the capability exists, animations may also be sent.

With this embodiment, similarly to the second embodiment, the data center 410 is capable of performing two kinds of processing as described above, and the effects of this embodiment are the same as those of the second embodiment.

The embodiments above have been explained with the premise that a user, or a customer of a power company confirms the state of a house subject to surveillance or the state of a sensing area of a sensor, when he or she is in a location separate from the house. However, the position of the user or customer may be anywhere. For example, if the user or customer is in a bedroom, for example, he or she is also able to confirm or observe the state of the entranceway, kitchen or another room. In addition, if the user or customer is therefore in the house, when a sensor has been activated, he or she is able to immediately confirm the state of a sensing area by moving to the sensing area of that sensor, and it is therefore also possible for the operation of a camera to be suspended. In such a circumstance, privacy can be preserved.

Although the present invention has been fully described by way of examples with reference to the accompanying drawings, it is to be noted here that various changes and modifications will be apparent to those skilled in the art. Therefore, unless such changes and modifications otherwise depart from the spirit and scope of the present invention, they should be construed as being included therein.

What is claimed is:

1. A surveillance system for confirming a state of a house, comprising:
a mobile terminal owned by a user;
a camera mounted on a part of the house, which is specified by the user; and
an information processing unit operable to transmit an image photographed by said camera to said mobile terminal in accordance with an instruction from said mobile terminal.

2. A surveillance system for confirming a state of a house, comprising:
a mobile terminal owned by a user;
a sensor mounted on a part of the house, which is specified by the user; and
an information processing unit operable to transmit information from said sensor to said mobile terminal.

3. A surveillance system for confirming a state of a house, comprising:
a mobile terminal owned by a user;
a sensor mounted on a part of the house, which is specified by the user; and
an information processing unit operable to transmit, when said sensor senses unusual event information, a text message corresponding to the unusual event information to said mobile terminal.

4. A surveillance system for confirming a state of a house, comprising:
a mobile terminal owned by a user;
a sensor mounted on a part of the house, which is specified by the user;
a camera operable to photograph a sensing area of said sensor; and
an information processing unit operable to transmit, when said sensor senses unusual event information, an image photographed by said camera to said mobile terminal.

5. A surveillance system for confirming a state of a house, comprising:
a mobile terminal owned by a user;
a sensor mounted on a part of the house, which is specified by the user;
a camera operable to photograph a sensing area of said sensor; and
an information processing unit having a memory that cumulatively stores images photographed by said camera when said sensor senses unusual event information, said information processing unit transmitting an image in said memory to said mobile terminal in accordance with an instruction from said mobile terminal.

6. A surveillance system for confirming a state of a house, comprising:
an information communications network constructed using an electrical power distribution network of a power company;
a mobile terminal owned by a customer of the power company;
a camera mounted on a part of the house, which is specified by the customer; and
an information processing unit connected to said information communications network for transmitting an image photographed by said camera to said mobile terminal in accordance with an instruction from said mobile terminal.

7. A surveillance system for confirming a state of a house, comprising:
an information communications network constructed using an electrical power distribution network of a power company;
a mobile terminal owned by a customer of the power company;
a sensor mounted on a part of the house, which is specified by the customer; and
an information processing unit connected to said information communications network for transmitting information from said sensor to said mobile terminal.

8. A surveillance system for confirming a state of a house, comprising:
an information communications network constructed using an electrical power distribution network of a power company;
a mobile terminal owned by a customer of the power company;
a sensor mounted on a part of the house, which is specified by the customer; and
an information processing unit connected to said information communications network for transmitting, when said sensor senses unusual event information, a text message corresponding to the unusual event information to said mobile terminal.

9. A surveillance system for confirming a state of a house, comprising:
an information communications network constructed using an electrical power distribution network of a power company;
a mobile terminal owned by a customer of the power company;
a sensor mounted on a part of the house, which is specified by the customer;
a camera operable to photograph a sensing area of said sensor; and
an information processing unit connected to said information communications network for transmitting, when said sensor senses unusual event information, an image photographed by said camera to said mobile terminal.

10. A surveillance system for confirming a state of a house, comprising:
an information communications network constructed using an electrical power distribution network of a power company;
a mobile terminal owned by a customer of the power company;
a sensor mounted on a part of the house, which is specified by the customer;
a camera operable to photograph a sensing area of said sensor; and
an information processing unit having a memory that cumulatively stores images photographed by said camera when said sensor senses unusual event information, said information processing unit being connected to said information communications network for transmitting an image in said memory to said mobile terminal in accordance with an instruction from said mobile terminal.

11. A surveillance system for confirming a state of a house of a customer of a power company, comprising:
an information communications network constructed using an electrical power distribution network of a power company;
a gateway unit installed on the house and connected to said information communications network for sending inspection results, of an automated inspection of measurement of electricity consumed by the customer, to said information communications network;
a mobile terminal owned by the customer;
a camera mounted on a part of the house, which is specified by the customer; and
an information processing unit connected to said information communications network for transmitting an image photographed by said camera to said mobile terminal in accordance with an instruction from said mobile terminal.

12. A surveillance system for confirming a state of a house of a customer of a power company, comprising:
an information communications network constructed using an electrical power distribution network of a power company;
a gateway unit installed on the house and connected to said information communications network for sending inspection results, of an automated inspection of measurement of electricity consumed by the customer, to said information communications network;
a mobile terminal owned by the customer;
a sensor mounted on a part of the house, which is specified by the customer; and
an information processing unit connected to said information communications network for transmitting information from said sensor to said mobile terminal.

13. A surveillance system for confirming a state of a house of a customer of a power company, comprising:
an information communications network constructed using an electrical power distribution network of a power company;
a gateway unit installed on the house and connected to said information communications network for sending inspection results, of an automated inspection of measurement of electricity consumed by the customer, to said information communications network;
a mobile terminal owned by the customer;
a sensor mounted on a part of the house, which is specified by the customer; and
an information processing unit connected to said information communications network for transmitting, when said sensor senses unusual event information, a text message corresponding to the unusual event information to said mobile terminal.

14. A surveillance system for confirming a state of a house of a customer of a power company, comprising:
an information communications network constructed using an electrical power distribution network of a power company;
a gateway unit installed on the house and connected to said information communications network for sending inspection results, of an automated inspection of measurement of electricity consumed by the customer, to said information communications network;
a mobile terminal owned by the customer;
a sensor mounted on a part of the house, which is specified by the customer;
a camera operable to photograph a sensing area of said sensor; and
an information processing unit connected to said information communications network for transmitting, when said sensor senses unusual event information, an image photographed by said camera to said mobile terminal.

15. A surveillance system for confirming a state of a house of a customer of a power company, comprising:
an information communications network constructed using an electrical power distribution network of a power company;
a gateway unit installed on the house and connected to said information communications network for sending inspection results, of an automated inspection of measurement of electricity consumed by the customer, to said information communications network;
a mobile terminal owned by the customer;
a sensor mounted on a part of the house, which is specified by the customer;
a camera operable to photograph a sensing area of said sensor; and
an information processing unit having a memory that cumulatively stores images photographed by said camera when said sensor senses unusual event information, said information processing unit being connected to said information communications network for transmitting an image in said memory to said mobile terminal in accordance with an instruction from said mobile terminal.
